(19) United States
(12) Patent Application Publication
(10) Pub. No.: US 2025/0273890 A1
(43) Pub. Date: Aug. 28, 2025

(54) Electrical Connection Element

(71) Applicant: Rosenberger Hochfrequenztechnik GmbH & Co. KG, Fridolfing (DE)

(72) Inventors: Andreas Gruber, Fridolfing (DE); Jakob Itzlinger, Fridolfing (DE)

(21) Appl. No.: 19/056,165

(22) Filed: Feb. 18, 2025

(30) Foreign Application Priority Data
Feb. 23, 2024 (EP) 24 159 287.2

(51) Int. Cl. H01R 13/11; H01R 43/16

(52) U.S. Cl. CPC H01R 13/11; H01R 43/16

(57) ABSTRACT

An electrical connection element for electrically connecting a contact element to an associated mating contact element has a metal strip with a first side end S₁ and a second side end S₂ and a center axis M. First portions are formed alternately along the center axis M at the first side end S₁ and second portions are formed alternately at the second side end S₂. Each first portion is connected to the two adjacent second portions via a third portion of the metal strip. The first portions and the second portions are each bent about an axis of rotation R₁, R₂, that runs parallel to the center axis M. The bent first portions are each arranged between the adjacent bent second portions. Each first portion and each second portion are bent to contact the contact element. The third portions are each set up to contact the mating contact element.

### FIELD OF THE INVENTION

The present invention relates to an electrical connection element for electrically connecting a contact element to an associated mating contact element.

The invention also relates to an electrical connection.

Lastly, the invention also relates to a method for producing an electrical connection element.

### TECHNICAL BACKGROUND

In a pluggable and detachable connection for the transmission of data and electrical energy, electrical plug connections consisting of an electrical plug connector and an associated electrical mating plug connector are known. When the plug connection is in the plugged state, contact elements of the plug connector make contact with associated mating contact elements of the mating plug connector. When transmitting electrical energy and therefore high currents, rigid contact elements and rigid mating contact elements, each with a sufficiently large cross-section, axe preferably used. A rigid contact element usually makes point contact with a rigid mating contact element rather than a flat contact. Also, no contact pressure is typically generated between a rigid contact element and a rigid mating contact element due to the lack of elasticity. Both of these factors reduce the transmission of high currents between the contact element and the mating contact element. To overcome this technical disadvantage, an electrical connection element with a sufficiently high number of elastically formed contacting areas is arranged between the rigid contact element and the rigid mating contact element.

A contact plate or contact sleeve with several contact blades is known as an electrical connection element for rotationally symmetrical or flat contact elements of mating contact elements. A contact sleeve with contact blades is disclosed, for example, in EP 3 357 127 B1. Such contact plates are usually long and have a small elastic spring range. They also lose their elasticity over time. Alternatively, a toroidal angular spring is used as an electrical connection element for rotationally symmetrical contact elements or mating contact elements, as disclosed in EP 2 387 113 B1, for example. Such a toroidal contact spring is disadvantageously associated with high production costs.

This is a situation that needs to be improved.

### DESCRIPTION OF THE INVENTION

Against this background, the present invention addresses the problem of creating an electrical connection element for electrically connecting a contact element to an associated mating contact element with improved electrical and mechanical properties and reduced production costs.

According to the invention, this problem is solved by an electrical connection element having the features of claim 1.

Accordingly, the following is provided:

An electrical connection element for electrically connecting a contact element to an associated mating contact element, comprising
a metal strip with a center axis,
wherein along the center axis, alternately at a first side end of the metal strip, in each case first portions of the metal strip and
second portions of the metal strip are formed at a second side end of the metal strip,
wherein each first portion is connected to the two nearest adjacent second portions via a third portion of the metal strip,
wherein the first portions and the second portions are each bent around an axis of rotation that runs parallel to the center axis,
wherein the bent first portions are each arranged between the two nearest adjacent bent second portions,
wherein each first portion and each second portion are each bent so as to contact the contact element, and
the third portions are each set up to contact the mating contact element.

The realization/idea underlying the present invention consists in forming, in an originally planar elongate metal strip with a center axis, relative to the center axis, alternately first portions of the metal strip at a first lateral end of the metal strip and second portions of the metal strip at an opposite second lateral end of the metal strip and connecting each first portion to the two next adjacent second portions via a respective third portion of the metal strip. Thus, a third portion of the metal strip is formed between each first portion of the metal strip and the respective nearest adjacent second portions of the metal strip, which connects the respective first portion of the metal strip to one of the respective two nearest adjacent second portions of the metal strip. This results in an originally planar metal strip with a periodic shape relative to the center axis, preferably with a wave-like shape relative to the center axis. Lastly, the first and second portions of a metal strip formed in this way are each bent about an axis of rotation parallel to the center axis in such a way that an electrical connection element with a sleeve-shaped or tubular basic geometry is formed, in which such bent first portion is arranged between the two next adjacent bent second portions. In this way, the first and second portions of the metal strip, which are each arranged alternately on a lateral-surface side of the sleeve-shaped or tubular electrical connection element, each form a contact to the contact element (preferably via associated contact points). The third portions of the metal strip, which are each arranged on the opposite side of the sheath of the sleeve or tubular electrical connection element, form a contact to the mating contact element (preferably via associated contact points).

The bent first and second portions of the metal strip, which are separated from each other by gaps located between them, each act as spring arms of the electrical connection element and, due to the elasticity of the spring arms, enable the contact element to be contacted with sufficient contact pressure. The third portions of the metal strip, which each connect a first and a second portion of the metal strip, are also separated from each other by gaps located between them and, due to their longitudinal extent, which is preferably a multiple of their transverse extent, have an elasticity in order to contact the mating contact element with a sufficient contact pressure.

Due to the elasticity of the first, second and third portions of the metal strip, a corresponding distance between the contact points of the first and second portions and the contact points of the third portions of the metal strip, i.e., a corresponding diameter of the sleeve-shaped or tubular cross-sectional profile of the electrical connection element, is set flexibly as a function of the distance between the contact element and the mating contact element. The elasticity of the spring-arm-shaped first and second portions is preferably higher than the elasticity of the third portions of the metal strip. Thus, the distance adjustment between, on the one hand, the contact points of the first and second portions and, on the other hand, the contact points of the third portions of the metal strip is largely achieved by elastic bending of the spring-arm-shaped first and second portions of the metal strip in the direction of the contact points of the third portions. However, the third portions of the metal strip can also be bent in the direction of the contact points of the first and second portions of the metal strip.

Preferably, the distance between the contact element and the associated mating contact element is constant, so that the diameter of the sleeve-shaped or tubular cross-sectional profile of the electrical connection element and thus the distance between the contact points of the first and second portions and the contact points of the third portions of the metal strip is constant over the entire longitudinal extent of the metal strip. Alternatively, a distance between the contact point of each individual first or second portion and the contact points of the respective next adjacent third portions of the metal strip can be set individually due to the individual elasticity of each individual first, second and third portion of the metal strip. Thus, in the event of production-related fluctuations in the contact surfaces of the contact element and the mating contact element, a distance between the contact element and the mating contact element with the electrical connection element that varies along the longitudinal extent of the metal strip can be bridged.

A stepped or continuous change to the contact surface of the contact element and/or to the contact surface of the mating contact element without changing the distance between the contact element and the mating contact element can also be bridged with the electrical connection element, as the distance between the contact point of each individual first ox each individual second portion can be changed in relation to the contact point of the respective adjoining third portion of the metal strip.

The fact that the bent first portions of the metal strip are arranged between the bent second portions of the metal strip results in an electrical connection element which, with a given elasticity, has sufficient mechanical stability both along the longitudinal extent of the metal strip and along the sleeve-shaped or tubular cross-sectional extent. The first and second portions of the metal strip, the longitudinal extent of which are each oriented in the direction of insertion of release of the arrangement comprising the contact element and the mating contact element, stabilize each other during an insertion or release operation between the contact element and the mating contact element and are advantageously not displaced in the direction of the center axis of the metal strip. This advantageous effect can be further enhanced by form-fittingly fixing the first and second portions of the metal strip to the contact element in a recess, preferably in a groove, of the contact element. The third portions of the metal strip form the contact to the mating contact element, which moves relative to the contact element in a plugging or release process and thus relative to the electrical connection element fixed to the contact element. The third portions of the metal strip, which have a higher rigidity and thus a higher mechanical stability than the first and second portions of the metal strip, can absorb the plugging or release forces from the electrical connection element that occur during a plugging or release process better than the first and second portions of the metal strip.

The contact element and the associated mating contact element are preferably each a rigid body made of a material with a high electrical conductivity, preferably a metal, in particular copper or aluminum, or a metal alloy.

The contact element and the mating contact element can each be designed as a flat contact, i.e., as a contact blade and an associated U-shaped contact element. The associated electrical connection element, which is arranged between the contact element and the mating contact element and makes lateral contact with the contact element and the mating contact element, thus has a sleeve-shaped or tubular basic geometry with a linear center axis. For the electrical connection between two flat contact elements, however, an electrical connection element with a circular center axis, i.e., with an annular or toroidal basic geometry, is also conceivable, the longitudinal axis of which is oriented perpendicular to the contact surfaces of the two flat contact elements.

Alternatively, the contact element and the mating contact element can each be designed as rotationally symmetrical contacts, i.e., as pin-shaped ox sleeve-shaped contacts. In this case, the associated electrical connection element, which is arranged between the contact element and the mating contact element and makes radial contact with the contact element and the mating contact element, has a sleeve-shaped or tubular basic geometry with a circular center axis, i.e., with a toroidal basic geometry. However, other geometries for the contact element and the associated mating contact element are also conceivable, for example a conical geometry or a geometry with a square, rectangular, polygonal or elliptical cross-sectional profile.

Lastly, the electrical connection element with an annular or toroidal basic geometry can also electrically connect a contact element and an associated mating contact element, each with a sleeve-shaped geometry, to each other at the end face.

The first and second portions of the metal strip, which in conjunction with the third portions of the metal strip form a periodic course of the metal strip, preferably each have a constant extent in a direction towards the center axis of the metal strip. Thus, the contact points formed on the individual first and second portions of the metal strip for contacting the contact element and the contact points formed on the individual third portions of the metal strip for contacting the mating contact element are spaced equidistantly from each other. In the case of a toroidal electrical connection element, the individual contact points are spaced apart from each other in equidistant angular segments. In both cases, a uniformly distributed transmission of high currents between the contact element and the mating contact element is realized, provided that the contact element and the associated mating contact element are each an inner conductor contact element. If the contact element and the associated mating contact element each form an outer conductor contact element, a good shielding density can be achieved with such a technical design.

However, in a less preferred embodiment of the invention, non-constant extent of the individual first, second and third portions of the metal strip and thus a non-constant spacing of the contact points is also conceivable.

The first and second portions of the metal strip can each be bent relative to an associated axis of rotation by such a large bending angle that, on the one hand, the individual bent first portions and the individual bent second portions are arranged interlaced with one another and, on the other hand, a largely closed lateral surface of the sleeve-shaped or tubular basic geometry of the electrical connection element is formed. Preferably, the axis of rotation about which the first portions of the metal strip are each bent is different from the axis of rotation about which the second portions of the metal strip are each bent. In this case, the cross-sectional profile of the sleeve-shaped or tubular basic geometry of the electrical connection element is ω-shaped. However, it is also conceivable that the first portions of the metal strip are each bent about several axes of rotation and the second portions of the metal strip are each bent about several other axes of rotation in order to achieve an electrical connection element with a more complex cross-sectional shape.

Advantageous embodiments and developments are described in the further dependent claims and in the description with reference to the figures in the drawing.

It is understood that the above-mentioned features and those to be explained below can be used not only in the combination indicated in each case, but also in other combinations or on their own, without going beyond the scope of the present invention.

The planar shaping of the metal strip with repeating sequences of a first portion, a third portion, a second portion and a third portion and the subsequent bending of the first and second portions can preferably be realized using a stamping and bending technique. In this way, such an electrical connection element can be produced in a highly automated process in large quantities at minimized production costs. The stamping and bending technique also enables simple adaptation to different parameters such as size, geometry and/or material of the electrical connection element to be manufactured.

In a further preferred embodiment of the invention, the electrical connection element can be realized for the electrical connection between a rotationally symmetrical contact element and a likewise rotationally symmetrical mating contact element. For this purpose, the center axis of the metal strip can preferably be bent in a circular shape, in particular relative to a longitudinal axis of the electrical connection element. The first portions and the second portions of the metal strip can each be bent in such a way that they contact the contact element radially outwards relative to the longitudinal axis of the electrical connection element. The third portions of the metal strip can each be set up to contact the mating contact element radially inwards relative to the longitudinal axis of the electrical connection element. The electrical connection element has a toroidal basic geometry. The expression “radially inward contacting” means contacting in a direction towards the longitudinal axis, while “radially outward contacting” means contacting in a direction away from the longitudinal axis.

Alternatively, a toroidal electrical connection element with an inner or outer cross-sectional profile that is elliptical, rectangular, square or polygonal to the longitudinal axis of the electrical connection element is also conceivable for the electrical connection of a contact element, the feedthrough of which alternatively has an elliptical, rectangular, square or polygonal cross-sectional profile, to a mating contact element, the cross-sectional profile of which is consequently elliptical, rectangular, square or polygonal.

The circularly bent center axis of the metal strip can in particular be circularly closed. For this purpose, a first axial end of the metal strip can preferably be connected to a second axial end of the metal strip, preferably in an integrally bonded manner, for example by means of welding or soldering. For this purpose, at least one welding or at least one soldering point can provide sufficient connection strength between the first axial end and the second axial end. Alternatively, a form-fit connection of the first axial end and the second axial end is also possible by means of clinching, for example.

In a less preferred embodiment of the invention, the circularly bent center axis of the metal strip can also be formed in a non-closed manner. In this case, the toroidal electrical connection element can, for example, be inserted in a suitably shaped circular groove of the contact element in such a way that the center axis of the metal strip undergoes a circular bend. The first axial end and the second axial end of the metal strip can come to rest in the circular groove in such a way that they make contact with each other or are slightly spaced apart.

So that the first portions and the second portions of the metal strip can each realize a contacting of the contact element and the first and the second portions of the metal strip are each arranged interlaced with one another, the first portions of the metal strip can each be bent in an opposite direction of rotation than the second portions of the metal strip. Each first portion of the metal strip can be bent in a clockwise direction, i.e., in a direction of rotation to the “right”, while each second portion of the metal strip can be bent in a counterclockwise direction, i.e., in a direction of rotation to the “left”.

In a preferred embodiment of the invention, the electrical connection element can have a toroidal basic geometry. The toroidal basic geometry of the electrical connection element can thus enable radial contact or, alternatively, end contact with the contact element and the mating contact element. The contact surfaces of the electrical connection element are thus improved both in the direction of the contact element and in the direction of the mating contact element while at the same time realizing elasticity. In addition, the toroidal basic geometry of the electrical connection element can enable current transmission via two current paths between the contact surfaces on the contact element side and the mating contact surfaces on the mating contact element side. The current transfer capability between the contact element and the mating contact element is therefore also improved while at the same time realizing elasticity. Lastly, the toroidal basic geometry of the electrical connection element can enable elasticity in the radial direction, in the axial direction and in the circumferential direction of the electrical connection element.

So that the bent first portions of the metal strip can be arranged within the toroidal basic geometry of the electrical connection element in an interlaced manner with respect to the bent second portions of the metal strip, each first portion of the metal strip must be insertable in the intermediate region between the two nearest adjacent second portions of the metal strip and each second portion of the metal strip must be insertable in the intermediate region between the two nearest adjacent first portions of the metal strip. In order to realize this, in a further preferred embodiment of the invention, the geometry of the second portions of the metal strip can each correspond to the geometry of a recess between the two nearest adjacent first portions of the metal strip, and the geometry of the first portions of the metal strip can each correspond to the geometry of the recess between the two nearest adjacent second portions of the metal strip. Here and in the following, the recess between two adjacent first portions of the metal strip is referred to as a first recess and the recess between two adjacent second portions of the metal strip is referred to as a second recess.

In order to realize the interlaced arrangement of the bent first and second portions of the metal strip, the size of each first portion of the metal strip may be at least slightly smaller than the size of a second recess and the size of each second portion of the metal strip may be at least slightly smaller than the size of a first recess as a further condition

The size of the first and second portions of the metal strip, the size of the first recesses and the size of the second recesses refer in each case both to the extent in one direction of the center axis of the metal strip and to the extent in a direction transverse to the center axis of the metal strip.

In a further preferred embodiment of the invention, the geometry of a first recess and of a second recess can in each case taper in the direction of the center axis. Such a geometric shaping of the metal strip favors a wave-shaped or zigzag-shaped course of the metal strip of the electrical connection element, which is composed of first portions, second portions and third portions respectively.

In a particularly preferred embodiment of the invention, the first recesses and the second recesses can each merge into a slot-shaped first or second recess between two third portions. The slot-shaped first or second recesses between two third portions of the metal strip in each case advantageously enable a good compromise between the largest possible contact surface of the third portions to the mating contact element and a necessary minimum elasticity in the region of the third portions of the electrical connection element.

The individual slot-shaped recesses can even extend over the third portions of the metal strip into the first and second portions of the metal strip. In this way, the elasticity of the first and second portions of the metal strip can be additionally increased, for example in order to be able to compensate even better for production-related unevenness on the inner surface of the contact element.

Correspondingly to the tapering geometry of the first and second recesses, the first portions and the second portions of the metal strip can also taper in the direction of the respective side end.

In order to further increase the elasticity of the electrical connection element in the area of the third portions of the metal strip, an extent of the third portions can be narrowed at least in portions in the direction of the center axis. The narrowed transverse extent of each third portion of the metal strip causes an increase in elasticity, particularly in the radial direction of the electrical connection element.

At least one contact point, preferably two contact points, can be formed on the first portions, on the second portions and on the third portions for the preferred point contacting of the contact element and the mating contact element. In order to realize equidistant contacting to the contact element and to the mating contact element, at least one contact point can preferably be formed in each first portion, in each second portion and in each third portion of the metal strip. The contact point can be formed as a contact bump or as a contact elevation, which can preferably be produced by embossing.

If two contact points are formed in the first portions, in the second portions and/or in the third portions of the metal strip, one contact point can be formed on each side edge of the first portion, the second portion and/or the third portion of the metal strip. The side edges of the first portions, the second portions and/or the third portions of the metal strip can preferably be cranked relative to a region of the first portions, the second portions and/or the third portions located between the side edges. In this way, the individual contact points are additionally raised in relation to the remaining surface regions of the first portions, the second portions and/or the third portions of the metal strip and thus the contact between the electrical connection element and the contact element and the mating contact element is additionally raised at all contact points and thus additionally secured.

In an alternative design of a contact point in a third portion of the metal strip, a contact point can be formed on each of the two flanks of a groove-shaped indentation of the third portion of the metal strip. The groove-shaped indentation can extend transversely to the longitudinal extent of the third portion between the two side edges of the third portion. The contact points can preferably be located on a longitudinal axis of the respective third portion or on a line parallel to the longitudinal axis. In this way, contact points can be formed in each case on a third portion of the metal strip, which are raised in relation to the other areas of the respective third portion and thus ensure secure contacting of the mating contact element.

Preferably, the individual contact points should each be formed at identical positions within the first, second and third portions of the metal strip in order to realize a regular distribution of the contact points within the electrical connection element. However, any other local arrangement of a contact point in the individual first, second and third portions of the metal strip is also conceivable.

The invention also covers an electrical connection comprising an electrical connector and an associated electrical mating connector. The connector has a contact element which is electrically connected to a mating contact element of the mating connector via an electrical connection element according to the invention. The technical features, technical details, technical effects and technical advantages explained above for the electrical connection element apply equivalently to the use of the electrical connection element in the electrical connection. The electrical connection element is arranged between the contact element and the mating contact element. The first portions and the second portions of the electrical connection element each contact the contact element electrically and mechanically and the third portions of the electrical connection element each contact the mating contact element electrically and mechanically. The contact element and the mating contact element can either each be an inner conductor contact element or an outer conductor contact element.

Preferably, the electrical connection consisting of an electrical connector and an associated electrical mating connector can be an electrical plug connection consisting of an electrical plug connector and an associated electrical mating plug connector. However, it is also conceivable that the electrical connection element makes electrical and mechanical contact with an outer conductor contact element in the form of a metal main housing and an outer conductor mating contact element in the form of a metal housing cover. In this case, the main housing is electrically and mechanically connected to the housing cover without a plugging process.

In a preferred embodiment of the electrical connection, the contact element and the associated mating contact element are each rotationally symmetrical, i.e., the contact element is shaped like a bush or sleeve and the mating contact element is shaped like a pin. The electrical connection element therefore has a toroidal basic geometry. Alternatively, the contact element and the associated mating contact element can each be designed as a flat contact. In this case, the electrical connection element has a linear sleeve-shaped basic geometry. Lastly, a metal housing cover, which forms an outer conductor mating contact element of the electrical connection, can follow the housing geometry of a metal main housing, which forms an outer conductor contact element of the electrical connection. In this case, the toroidal electrical connection element fits the housing geometry.

The electrical connection element is preferably inserted in an annular recess in the contact element. The recess for receiving the electrical connection element can preferably be formed as an annular groove on the inner surface of the contact element. Alternatively, a combination of a shoulder formed on the inner lateral surface of the contact element and at least one latching tab or latching hook formed on the inner lateral surface of the contact element to accommodate the electrical connection element is also conceivable. The electrical connection element is preferably form-fittingly fixed in the recess of the contact element. A frictionally engaged or integrally bonded fixing of the electrical connection element to the contact element is also conceivable in a less preferred configuration. Fixing the electrical connection element to the contact element enables secure electrical contact between the individual first and second portions of the metal strip of the electrical connection element and the contact element. In a less preferred embodiment of the invention, the electrical connection element can also be inserted in an annular recess of the mating contact element.

Lastly, the invention also covers a method for producing an electrical connection element which electrically connects a contact element to an associated mating contact element. The method has at least the following method steps:
providing a stamped metal strip with a center axis, wherein first portions of the metal strip are formed alternately along the center axis at a first side end of the metal strip and second portions of the metal strip are formed alternately at a second side end of the metal strip, wherein each first portion is connected to the two next adjacent second portions via a third portion of the metal strip,
bending the first portions and the second portions each about an axis of rotation which is parallel to the center axis, so that the bent first portions are each disposed between the two next adjacent bent second portions, each bent first portion and each bent second portion is capable of contacting the contact element, and the third portions are capable of contacting the mating contact element, and
connecting, in an integrally bonded or form-fitting manner, a first axial end of the metal strip to a second axial end of the metal strip.

It should be emphasized at this juncture that the method steps mentioned do not necessarily have to be carried out in the order in which they are first described or mentioned. For example, individual method steps or groups of method steps may be interchangeable, if this is not technically impossible. Method steps can also be combined with each other, divided into separate intermediate steps or supplemented with intermediate steps. The method is also not necessarily exhaustively described with the method steps described and can be supplemented with further method steps, including those not mentioned.

The technical features, technical details, technical effects and technical advantages described above for the electrical connection element and the electrical connection apply equivalently to the production of the electrical connection element.

The above embodiments and developments can be combined with each other as desired, if appropriate. Other possible embodiments, developments and implementations of the invention also include combinations of features of the invention described above or in the following with regard to the embodiments. In particular, a person skilled in the art will also add individual aspects as improvements or additions to the respective basic form of the present invention.

### SUMMARY OF THE DRAWING

The present invention is explained in greater detail below with reference to the embodiments shown in the schematic figures in the drawing, in which:

FIG. 1A shows a representation of a planar stamping pattern of the electrical connection element according to the invention,

FIG. 1B shows an illustration of the pre-bent electrical connection element according to the invention,

FIG. 1C shows an isometric representation of the final produced electrical connection element according to the invention,

FIG. 1D shows a plan view of the final produced electrical connection element according to the invention,

FIG. 1E shows a side view of the final produced electrical connection element according to the invention,

FIG. 1F shows a partial representation of the final produced electrical connection element according to the invention,

FIG. 2A shows a partial representation of the electrical connection element according to the invention with the axial connection of the metal strip,

FIG. 2B shows a partial representation of the electrical connection element according to the invention with the carrier attachment,

FIG. 3A shows an illustration of a first formation of contact points on first and second portions of the electrical connection element according to the invention,

FIG. 3B shows an illustration of a second formation of contact points on first and second portions of the electrical connection element according to the invention,

FIG. 3C shows a side view of first and second portions of the electrical connection element according to the invention with contact points,

FIG. 3D shows a sectional view of first and second portions of the electrical connection element according to the invention with contact points,

FIG. 3E shows a further sectional view of first and second portions of the electrical connection element according to the invention with contact points, and

FIG. 3F shows an illustration of a first formation of contact points on third portions of the electrical connection element according to the invention,

FIG. 3G shows a sectional view of a first formation of contact points on third portions of the electrical connection element according to the invention,

FIG. 3H shows an illustration of a second formation of contact points on third portions of the electrical connection element according to the invention,

FIG. 3I shows a sectional view of a second formation of contact points on third portions of the electrical connection element according to the invention,

FIG. 4 shows a representation of a modified planar stamping pattern of the electrical connection element according to the invention, and

FIG. 5 shows an illustration of an electrical connection according to the invention.

The accompanying figures of the drawing are intended to provide a further understanding of the embodiments of the invention. They illustrate embodiments and, in conjunction with the description, serve to explain principles and concepts of the invention. Other embodiments and many of the advantages mentioned will become apparent with reference to the drawings. The elements of the drawings are not necessarily shown to scale with respect to each other.

In the figures in the drawing, like, functionally like and identically acting elements, features and components are each provided with the same reference signs, unless otherwise specified.

In the following, the figures are described coherently and comprehensively.

### DESCRIPTION OF EXEMPLARY EMBODIMENTS

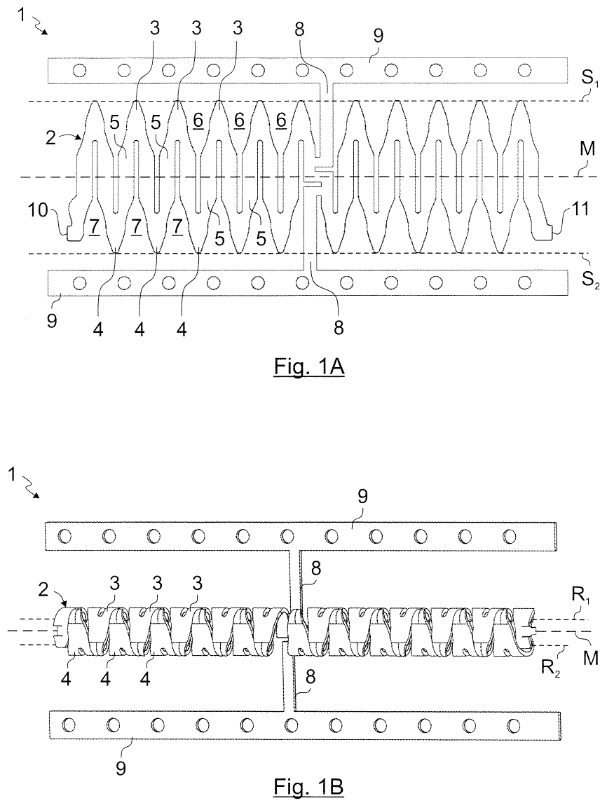

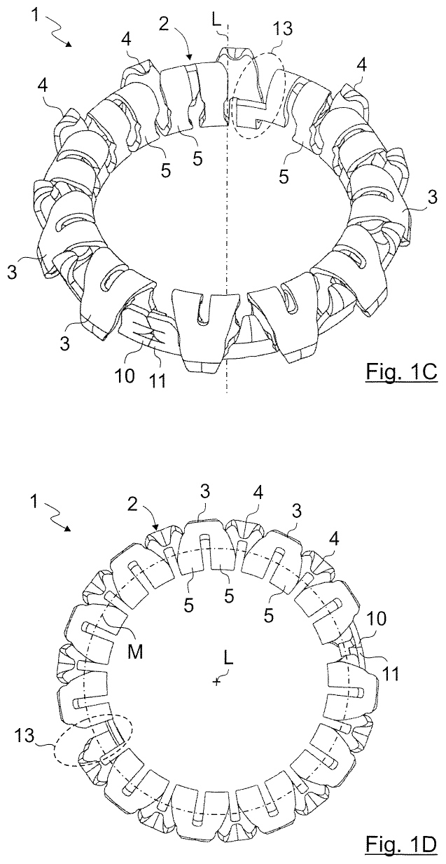

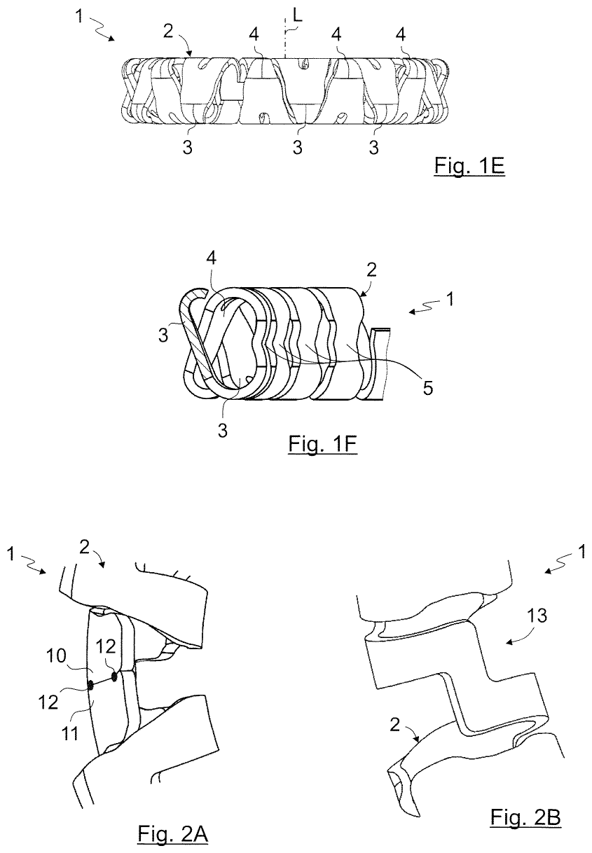

FIGS. 1A to 1C show the electrical connection element 1 in each of its individual manufacturing steps:

FIG. 1A shows the planar stamping pattern of the electrical connection element 1. The metal strip 2 of the electrical connection element 1 has a longitudinal extent along its center axis M and a transverse extent between a first side end S₁ and a second side end S₂. The metal strip 2 has a periodic or undulating course along its center axis M with first portions 3 at the first lateral end S₁, second portions 4 at the second lateral end S₂ and third portions 5 between the first portions 3 and the second portions 4. Each first portion 3 of the metal strip 2 is connected to the next adjacent second portions 4 of the metal strip 2 via a respective third portion 5 of the metal strip 2. The geometry of a first recess 6 between two successive first portions 3 of the metal strip 2 corresponds to the geometry of a second portion 4. Equivalently, a second recess 7 between two successive second portions 4 of the metal strip 2 corresponds to the geometry of a first portion 3.

Thus, after bending the first portions 3 and the second portions 4 of the metal strip 2 according to FIG. 1B, the first portions 3 and the second portions 4 of the metal strip 2 are arranged interlaced with each other, i.e., a second portion 4 of the metal strip 2 is arranged between each two successive first portions 3. The first recesses 6 and the second recesses 7 each taper in the direction of the center axis M and merge into slit-shaped first recesses 6 and slit-shaped second recesses 7, respectively, which Separate successive third portions 5 of the metal strip 2 from each other. Correspondingly, the first portions 3 and the second portions 4 of the metal strip 2 taper towards the first side end S₁ and towards the second side end S₂ respectively.

The metal strip 2 is connected to a carrier strip 9 at periodic intervals on both sides of the center axis M via a connecting region 8.

FIG. 1B shows an electrical connection element 1 with a metal strip 2, the first portions 3 and the second portions 4 of which are each bent about an axis of rotation R₁ and R₂ respectively, which in each case runs parallel to the center axis M of the metal strip 2. As can be seen from FIG. 1B, the first portions 3 are arranged alternately interlaced with the second portions 4 of the metal strip 2.

Lastly, the first axial end 10 of the metal strip 2 is connected to the second axial end 11 of the metal strip 2 preferably by means of at least one spot weld 12, for example by means of two spot welds 12 as shown in FIG. 2A. In this way, a toroidal electrical connection element 1 is formed with a center axis M of the metal strip 2, which is bent in a circle or runs in a circle relative to a longitudinal axis L of the electrical connection element 1.

The electrical connection element 1 thus finally produced is shown in an isometric view as shown in FIG. 1C and in a plan view in the direction of the longitudinal axis L as shown in FIG. 1D. Lastly, FIG. 1E shows a side view of the electrical connection element 1 in a radial direction relative to the longitudinal axis L.

The partial view of the electrical connection element 1 in FIG. 1F shows the spring-arm shape of the first portions 3 and the second portions 4 of the metal strip 2, which each form a radially outward-acting elasticity of the electrical connection element 1 relative to the longitudinal axis L. The third portions 5 of the metal strip, which each have a significantly smaller transverse extent compared to their longitudinal extent, each form a radially inward-acting elasticity of the electrical connection element 1 relative to the longitudinal axis L.

Lastly, FIG. 2B shows the attachment region 13 of the metal strip 2 of the electrical connection element 1 to the two carrier strips 9. In the attachment region 13, the distance between two consecutive first portions 3 and/or the distance between two consecutive second portions 4 of the metal strip 2 is increased compared to the otherwise constant distance between two consecutive first portions 3 or between two consecutive second portions 4.

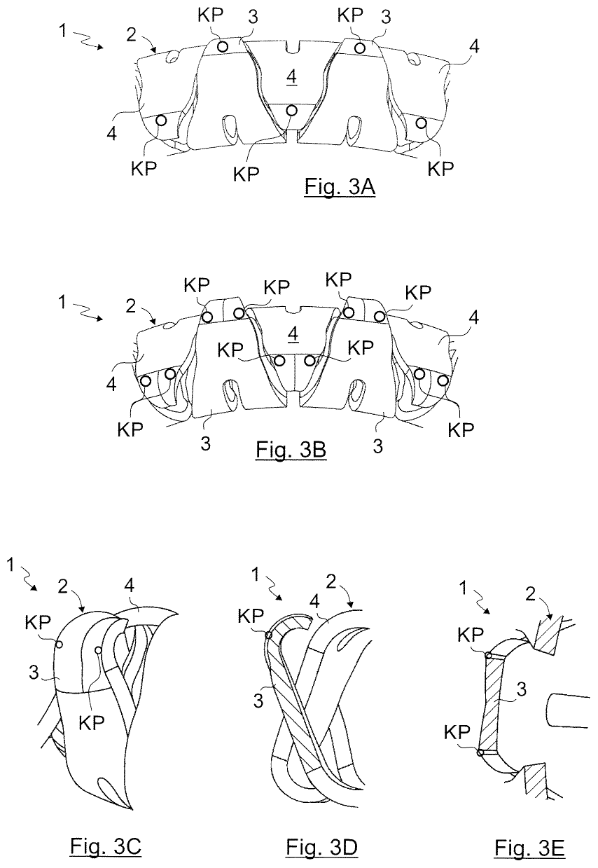

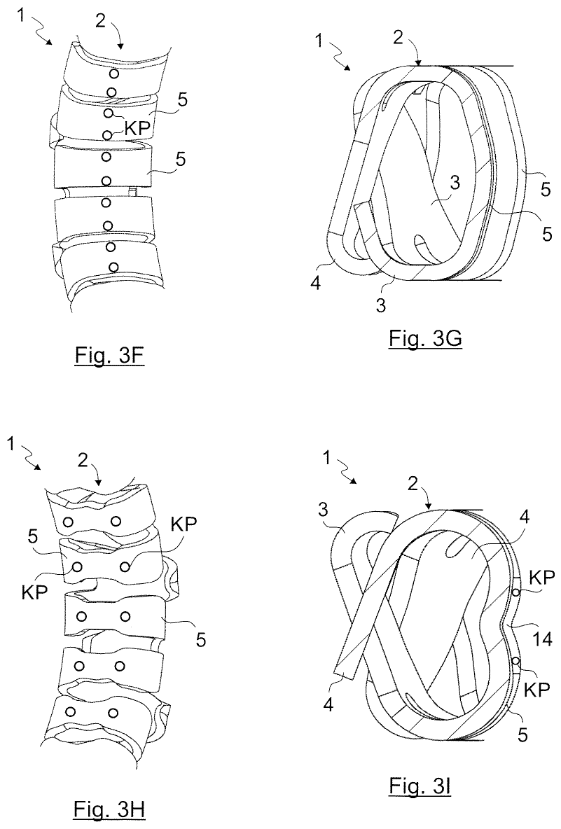

FIG. 3A shows a first formation of contact points KP in the first portions 3 and in the second portions 4 of the metal strip 2. Here, a single contact point KP is formed in the inner region of first portion 3 and each second portion 4 of the metal strip 2, preferably in each case at the tapered side end S₁ and S₂ of the metal strip 2.

FIG. 3B shows a second formation of contact points KP in the first portions 3 and in the second portions 4 of the metal strip 2. Here, two contact points KP are formed in each first portion 3 and in each second portion 4. One of the two contact points KP is formed on each side edge of the cranked first portions 3 and the cranked second portions 4 of the metal strip 2. The cranked shape of the first portions 3 and the second portions 4 of the metal strip 2 can be seen more clearly in the side view of the first and second portions 3 and 4 shown in FIG. 3C and in the two sectional views of the first and second portions 3 and 4 of the metal strip 2 shown in FIGS. 3D and 3E.

FIGS. 3F and 3G show a first formation of contact points KP on third portions 5 of the metal strip 2. Here, two contact points KP are formed in each third portion 5, with one of the two contact points KP being positioned on each side edge of the third portion 5.

While the transverse extent of the third portions 5 of the metal strip 2 in the representations of FIGS. 3F and 3G is realized constantly over the entire longitudinal extent of the individual third portions 5, the transverse extent of the third portions 5 of the metal strip 2 in the representations of FIGS. 3H and 3I is narrowed in each case in order to achieve greater elasticity of the third portions 5. In addition, an indentation 14, in particular a groove-shaped or bead-shaped indentation 14, is formed in each third portion 5 of the metal strip 2 in the direction of the transverse extent. One of two contact points KP is formed on each of the two flanks of the groove- or bead-shaped indentation 14 of the individual third portions 5 of the metal strip 2.

While FIG. 1A shows a metal strip 2 which is cut to its length of use on the one hand and is connected to two carrier strips 9 via a connecting region 8 on the other hand, FIG. 4 shows a metal strip 2 which is not connected to carrier strips 9 on the one hand and is only out to its length of use from a material by the meter after the punching process. As an alternative to the carrier strip transport, the metal strip 2 can be transported by means of several mandrels of the automatic punching and bending machine, each of which engages in a lateral extent E of a slot-shaped first recess 6 of a slot-shaped second recess 7 in the region between two adjacent third portions 5 of the metal strip 2.

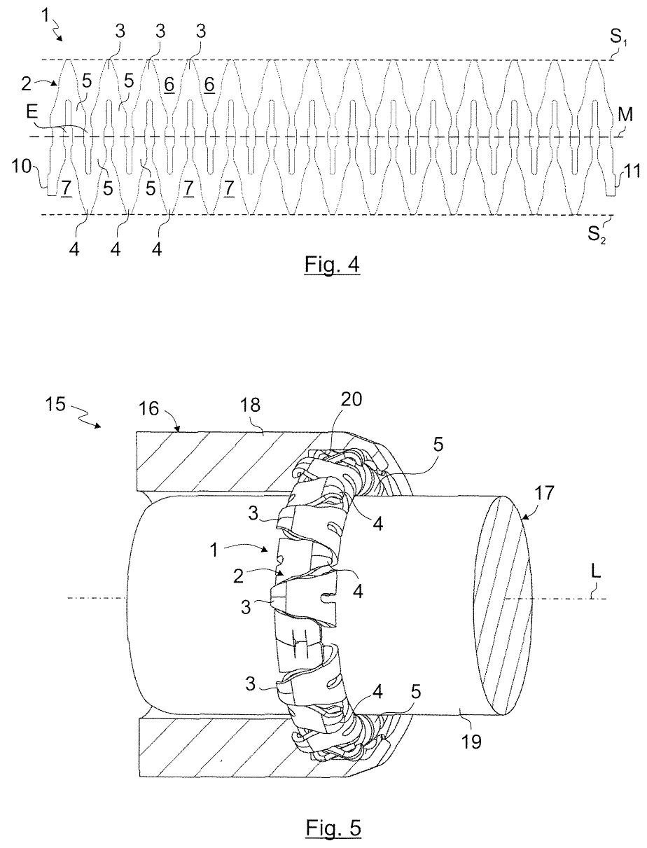

Lastly, FIG. 5 shows an electrical connection 15 consisting of an electrical connector 16 and an associated electrical mating connector 17. The electrical connection 15 is shown here as an electrical plug connection with an electrical plug connector and an associated electrical mating plug connector. The electrical connector 16 has, for example, a socket-shaped contact element 18, which is electrically and mechanically connected via the toroidal electrical connection element 1 to a mating contact element 19 of the electrical mating connector 17, for example, which is pin-shaped. The toroidal electrical connection element 1 is inserted into an annular recess 20 of the contact element 18 and mechanically connected to it form-fittingly.

It can be seen from FIG. 5 that the first portions 3 and the second portions 4 of the metal strip 2 of the toroidal electrical connection element 1 each contact the contact element 18 in equidistant angular segments radially outwards relative to the longitudinal axis L of the electrical connection element. The third portions 5 of the metal strip 2 of the toroidal electrical connection element 1 each contact the mating contact element 19 in equidistant angular segments radially inwards relative to the longitudinal axis L of the electrical connection element 1.

Although the present invention has been fully described above with reference to preferred embodiments, it is not limited thereto, but can be modified in a variety of ways.

1. An electrical connection element (1) for electrically connecting a contact element (18) to an associated mating contact element (19), the electrical connection element (1) comprising:
a metal strip (2) that defines a first side end (S₁), and a second side end (S₂), and a center axis (M) between the first side end (S₁) and the second side end (S₂); and
first portions (3) of the metal strip (2) are formed along the first side end (S₁) of the metal strip (2); and
second portions (4) are formed along the second side end S₂ of the metal strip (2); and wherein
the first portions (3) along the first side end (S₁), and the second portions (4) along the second side end (S₁), alternate relative to one another along the center axis (M); and
a third portion (5) of the metal strip (2) connects each first portion (3) to the two next adjacent second portions (4), and a third portion (5) of the metal strip (2) connects each second portion (4) to the next two adjacent first portions (3); and wherein
the first portions (3) are each bent about an axis of rotation R₁ which runs parallel to the center axis (M); and
the second portions (4) are each bent about an axis of rotation R₂ which runs parallel to the center axis (M); and wherein
the bent first portions (3) are each arranged between the two next adjacent bent second portions (4); and
each bent first portion (3) and each bent second portion (4) is able to contact the contact element (18); and
the third portions (5) are able to contact the mating contact element (19); and wherein
each third portion (5) is spaced apart from a next adjacent third portion (5) by a gap.

2. The electrical connection element (1) as claimed in claim 1 and wherein the electrical connection element (1) is produced as a stamped and bent part.

3. The electrical connection element (1) as claimed in claim 1 and wherein the center axis (M) is bent in a circle relative to a longitudinal axis (L) of the electrical connection element (1); and
the electrical connection element (1) is able to contact the contact element (18) radially outwards relative to the longitudinal axis (L); and
the electrical connection element (1) contacts the mating contact element (19) radially inwards relative to the longitudinal axis (L); and
each bent first portion (3) and each bent second portion (4) is bent in such a way as to contact the contact element (18) radially outwards; and
each third portion (5) is able to contact the mating contact element (19) radially inwards.

4. The electrical connection element (1) as claimed in claim 3 and wherein the metal strip (2) is circularly closed along the center axis (M).

5. The electrical connection element (1) as claimed in claim 4 and wherein the metal strip (2) has a first axial end (10) and a second axial end (11); and
the second axial end (11) is connected to the first axial end (10).

6. The electrical connection element (1) as claimed in claim 1 and wherein the first portions (3) are bent in a direction of rotation opposite to a direction of rotation of the second portions (4).

7. The electrical connection element (1) as claimed in claim 1 and wherein the electrical connection element (1) has a toroidal geometry.

8. The electrical connection element (1) as claimed in claim 1 and wherein a geometry of the second portions (4) corresponds to a geometry of a first recess (6) defined between two adjacent first portions (3); and
a geometry of the first portions (3) corresponds to a geometry of a second recess (7) defined between two adjacent second portions (4).

9. The electrical connection element (1) as claimed in claim 8 and wherein the geometry of the first recess (6) tapers in a direction towards the center axis (M); and
the geometry of the second recess (7) tapers in a direction towards the center axis (M).

10. The electrical connection element (1) as claimed in claim 1 and wherein an extent of the third portions (5) in a direction parallel to the center axis (M) is narrowed at least in portions.

11. The electrical connection element (1) as claimed in claim 1 and further comprising:
a contact point (KP), formed on the first portions (3);
a contact point (KP) formed on the second portions (4); and
a contact portion (KP) formed on the third portions (5).

12. The electrical connection element (1) as claimed in claim 11 and wherein the contact point (KP) is formed at each side edge of the first portions (3);
a contact point (KP) is formed at each side edge of the second portions (4); and/or
a contact point (KP) is formed at each side edge of the third portions (5).

13. The electrical connection element (1) as claimed in claim 11 and further comprising:
an indentation (14) formed on each of the third portions (5), and the indentation (14) has two flanks; and
a contact point (KP) is formed on each of the two flanks of the indentation (14).

14. An electrical connection (15) comprising:
an electrical connector (16) having a contact element (18); and
an associated electrical mating connector (17) having an associated mating contact element (19); and
an electrical connection element (1) that comprises
a metal strip (2) that defines a first side end (S₁) and a second side end (S₂), and a center axis (M) between the first side end (S₁) and the second side end (S₂), and
first portions (3) of the metal strip (2) are formed along the first side end S₁ of the metal strip (2), and
second portions (4) of the metal strip (2) are formed along the second side end S₂ of the metal strip (2), and wherein
the first portions (3) along the first side end (S₁), and the second portions (4) along the second side end (S₂), alternate relative to one another along the center axis (M), and
a third portion (5) of the metal strip (2) connects each first portion (3) to the two next adjacent second portions (4), and a third portion (5) of the metal strip (2) connects each second portion (4) to the two next adjacent first portions (3), and wherein
the first portions (3) are each bent about an axis of rotation R₁ which runs parallel to the center axis (M), and
the second portions (4) are each bent about an axis of rotation R₂ which runs parallel to the center axis (M), and wherein
each bent first portion (3) is each arranged between the two next adjacent bent second portions (4), and wherein
each bent first portion (3), and each bent second portion (4), contact the contact element (18), and
the third portions (5) contact the associated mating contact element (19); and
the electrical connection element (1) is arranged between the contact element (18) and the associated mating contact element (19)); and
the first portions (3) and the second portions (4) of the electrical connection element (1) contact the contact element (18) electrically and mechanically; and
the third portions (5) of the electrical connection element (1) contact the associated mating contact element (19) electrically and mechanically; and wherein
the third portions (5) are spaced apart from one another by gaps.

15. A method for producing an electrical connection element (1) for electrically connecting a contact element (18) to an associated mating contact element (19), the method comprising at least the following method steps:
providing a stamped metal strip (2) that defines a first side end (S₁) and a second side end (S₂), and a center axis (M) between the first side end (S₁) and the second side end (S₂), and
first portions (3) of the stamped metal strip (2) are formed along the first side end S₁ of the stamped metal strip (2), and
second portions (4) of the stamped metal strip (2) are formed along the second side end (S₂) of the stamped metal strip (2), and wherein
the first portions (3) along the first side end (S₁), and the second portions (4) along the second side end (S₂), alternate relative to one another along the center axis (M), and
a third portion (5) of the stamped metal strip (2) connects each first portion (3) to the two next adjacent second portions (4), and a third portion (5) of the stamped metal strip (2) connects each second portion (4) to the two next adjacent first portions (3); and
bending the first portions (3) about an axis of rotation R₁, and bending the second portions (4) about an axis of rotation R₂, which in each case runs parallel to the center axis (M), so that the bent first portions (3) are positioned between the two next adjacent bent second portions (4), and each bent first portion (3), and each bent second portion (4) is capable of contacting the contact element (18), and the third portions (5) are capable of contacting the associated mating contact element (19); and
connecting a first axial end (10) of the stamped metal strip (2) to a second axial end (11) of the stamped metal strip (2).

16. The electrical connection element (1) as claimed in claim 1 and further comprising:
plural contact points (KP) formed on the first portions (3); and
plural contact points (KP) formed on the second portions (4); and
plural contact points (KP) formed on the third portions (5).

17. The method of producing an electrical connection of claim 15 wherein the connecting of the first axial end (10) of the stamped metal strip (2) to the second axial end (11) of the stamped metal strip (2) is in an integrally bonded or form-fitting manner.

18. The electrical connection element (1) as claimed in claim 8 and wherein the geometry of the first recess (6) tapers in the form of a slit between two spacedly adjacent third portions (5); and
the geometry of the second recess (7) tapers in the form of a slit between two spacedly adjacent third portions (5).

19. The electrical connection element (1) as claimed in claim 11 and wherein the side edges are cranked or jogged such that the contact point (KP) is offset relative to a region of the first portions (3), relative to a region of the second portions (4) and/or relative to a region of the third portions (5) located between the side edges.

20. The electrical connection element (1) as claimed in claim 13 and wherein a contact point (KP) is formed on each of the two flanks of the Indentation (14); and
the contact points (KP) lie on a line parallel to the longitudinal extent of the third portions (5).
